(19) United States
(12) Patent Application Publication
(10) Pub. No.: US 2006/0125789 A1
(43) Pub. Date: Jun. 15, 2006

(54) Contactless input device

(76) Inventors: Jiawen Tu, Shanghai (CN); Xiaoling Shao, Shanghai (CN); Lei Feng, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,189

(22) PCT Filed: Nov. 28, 2003
(86) PCT No.: PCT/IB03/05583

§ 371 Date: Nov. 23, 2005

(30) Foreign Application Priority Data
Dec. 23, 2002 (CN) 02157875.3

(51) Int. Cl. G09G 5/08

(52) U.S. Cl. 345/158

(57) ABSTRACT

The present invention provides an input device that gives users more flexibility and convenience by allowing them to move the input device in a three-dimensional (3D) space without requiring any flat surface. According to one embodiment of the invention, an input device is provided. The input device comprises a motion detection sensor that generates (3D) motion data associated with (3D) movement of the input device. The device wirelessly transmits the motion data to a computer to cause the computer to derive a distance and direction of the movement of the input device in a two-dimensional plane based on the motion data. The computer then moves a cursor to a corresponding position based on the distance and direction derived. The input device also generates control signals in response to a user's command to cause the computer to perform a corresponding cursor action, e.g., a double click operation.

### BACKGROUND OF THE INVENTION

The invention relates generally to input devices, and more particularly to contactless input devices.

Input devices are used to feed data into computers or handheld devices, etc. Computer mice and trackballs are all examples of input devices. A computer mouse is a widely-used input device that controls the movement of the cursor on a display. A trackball is a mouse lying on its back and is popular for portable computers. At present, most conventional input devices suffer from drawbacks. For example, with a conventional mouse, wired or wireless, a user has to operate it on a flat surface, such as a mouse pad. This limits the choices available to the users. For instance, if a user wants to use it during a presentation or a lecture, he or she would have to go to the place where the mouse is located to use it, or control a wireless mouse on a flat surface. This can cause much inconvenience for the user while standing in the middle of the room, giving the presentation or lecture.

Therefore, there is a need to provide an improved input device that gives users more flexibility and convenience than that offered by conventional input devices.

### SUMMARY OF THE INVENTION

The present invention provides an input device that gives users more flexibility and convenience by allowing the users to move the input device in a three-dimensional (3D) space without requiring any flat surface.

In accordance with one embodiment of the invention, an input device is provided. The input device comprises a motion detection sensor that generates 3D motion data associated with 3D movement of the input device. The device wirelessly transmits the motion data to a computer to cause the computer to derive a distance and direction of the movement of the input device in a two-dimensional plane based on the motion data. The computer then moves a cursor to a corresponding position based on the distance and direction derived. The input device also generates control signals in response to a user's command to cause the computer to perform a corresponding cursor action, including a left click operation, a right click operation, a double click operation, and a click and drag operation.

In another embodiment of the invention, the motion data of the input device on first and second axes are used to derive a corresponding position of a cursor, while the motion data on a third axis are used as a basis to perform a corresponding cursor action.

In this way, the invention provides users with more flexibility and convenience than that offered by conventional input devices.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 shows an input device connected to a computer according to a first embodiment of the invention;

FIG. 2 shows an exemplary external design of input device according to the first embodiment of the invention;

FIG. 3 is a flowchart diagram illustrating a process performed by a computer according to the first embodiment of the invention;

FIG. 4 shows an input device connected to a computer according to a second embodiment of the invention;

FIG. 5 shows an exemplary external design of input device according to the second embodiment of the invention; and

FIG. 6 is a flowchart diagram illustrating a process performed by a computer according to the second embodiment of the invention.

Throughout the drawings, the same reference numerals indicate similar or corresponding features or functions.

### DETAILED DESCRIPTION OF THE PREFERRED EMBODIMENTS

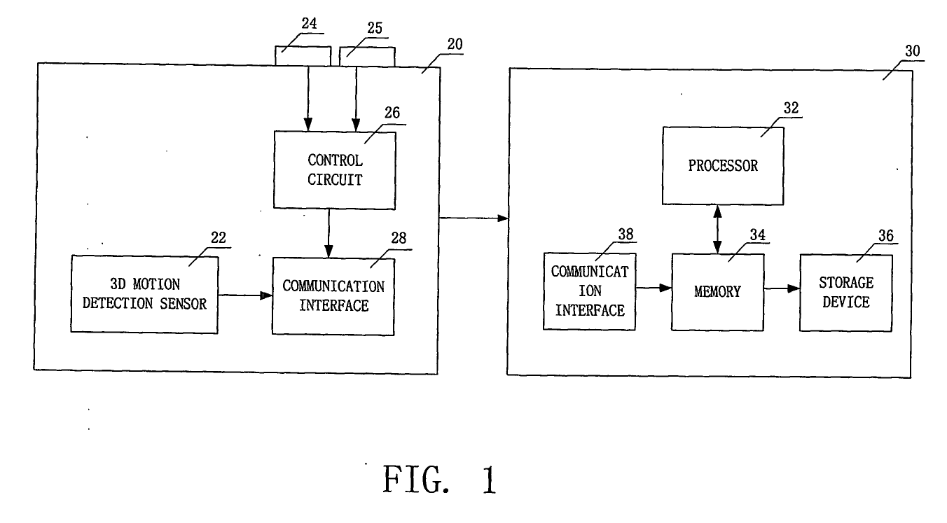

FIG. 1 shows an input device 20 connected to a computer 30 according to a first embodiment of the invention. As illustrated, input device 20 includes a three-dimensional (3D) motion detection sensor 22, left and right control buttons 24 and 25, a control circuit 26, and a communication interface 28. Computer 30 includes a processor 32, a memory 34, a storage device 36, and a communication interface 38. For simplicity, other conventional elements are not shown in FIG. 1.

In operation, a user moves input device 20 to point and click, in a 3D space (e.g., in the air), icons on computer 30. Motion detection sensor 22 detects the 3D motion and communicates the 3D motion data and a sampling rate to computer 30 for moving the cursor on the computer, via a communication interface 28, such as Bluetooth, Zigbee, IEEE 802.11, infrared. The sampling rate may be a predetermined value set by a manufacturer. From the motion data and the sampling rate received from input device 20, processor 32 calculates the corresponding 3D coordinates on the x, y and z axes and moves the cursor to a corresponding position on a display of the computer based on the calculated coordinates, or performs a corresponding cursor action.

Control circuit 26 of input device 20 provides one of two control signals to computer 30 via interface 28 upon receiving a user provided external input via control buttons 24 and 25. The two control signals represent left and right clicking operations respectively. For example, the user may press left control button 24 to cause control circuit 26 to generate a first control signal for computer 30 to perform an operation corresponding to a left clicking on a conventional mouse.

In a specific embodiment of the invention, motion detection sensor 22 detects the 3D motion by measuring the acceleration of the movement along the x, y and z axes. As an example, the piezoresistive-type tri-axial accelerating sensor commercially available from Hitachi Metals, Ltd., Tokyo, Japan, may be used as motion detection sensor 22. This accelerating sensor in the form of an IC chip has the ability to simultaneously detect acceleration in the three axial directions (x, y and z). The senor is highly sensitive and shock resistant and is a very small and thin semiconductor type 3 axial accelerating sensor. More information about this accelerating sensor is available on the following website http://www.hitachimetals.co.jp/e/prod/prod06/p06_{—}10.html, the disclosures of which is hereby incorporated by reference.

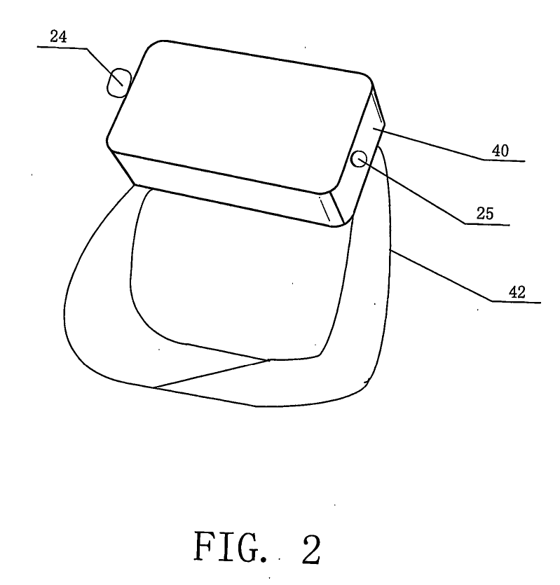

FIG. 2 shows an exemplary external design of input device 20 according to the first embodiment of the invention. As shown in FIG. 2, input device 20 includes a housing 40 that contains the electronics parts of the device (such as a 3D motion detection sensor IC chip), left and right control buttons 24 and 25, and a band 42 for mounting input device 20 on the user's finger. By mounting it on the finger, the user can simply move the finger in a 3D space to point to icons on the computer display and press one of the control buttons for causing corresponding click operation to be performed.

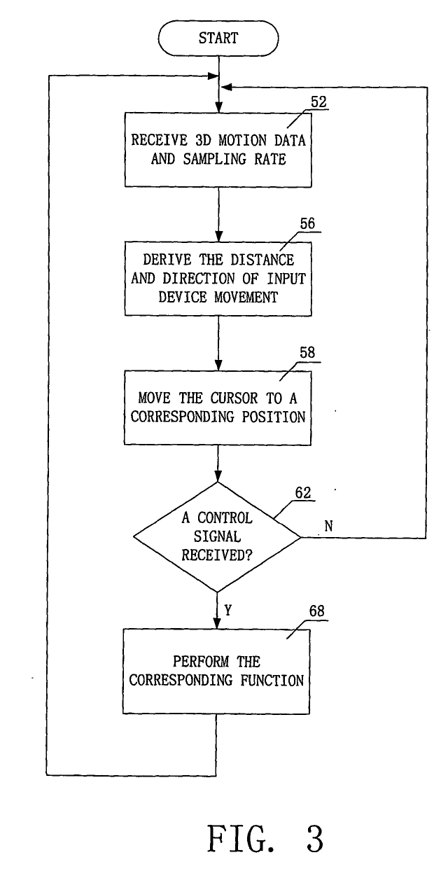

FIG. 3 is a flowchart diagram illustrating a process 50 performed by computer 30, according to the first embodiment of the invention. In FIG. 3, computer 30 receives the 3D motion data (such as the acceleration data of the movement in the x, y and z directions) and the sampling rate from input device 20 (step 52). Based on the information received, processor 32 calculates the corresponding coordinates on the x and y axes for each sampling point using the starting point of the movement as the origin to derive the distance and direction of the input device movement (step 56). At this step, each sampling point is in turn used as a reference point for calculating the coordinates of the following sampling point. Processor 32 then moves the cursor along the x and y axes to a corresponding position on the display (step 58). Calculation of the distance of the input device movement is continuously performed based on the incoming 3D motion data until processor 32 detects receipt of a control signal (step 62). If a control signal is received, it indicates that a control button is pressed. Therefore, a corresponding function is performed (step 68). Thereafter, the same process is repeated.

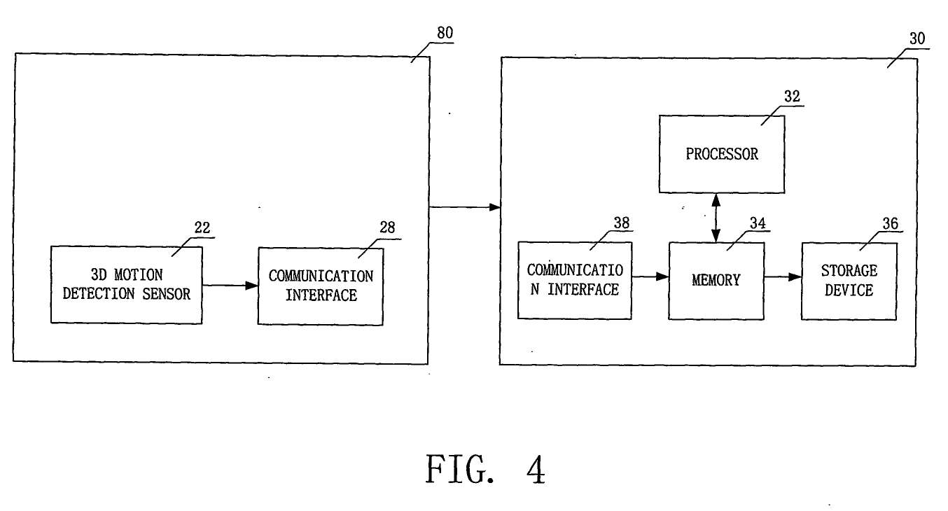

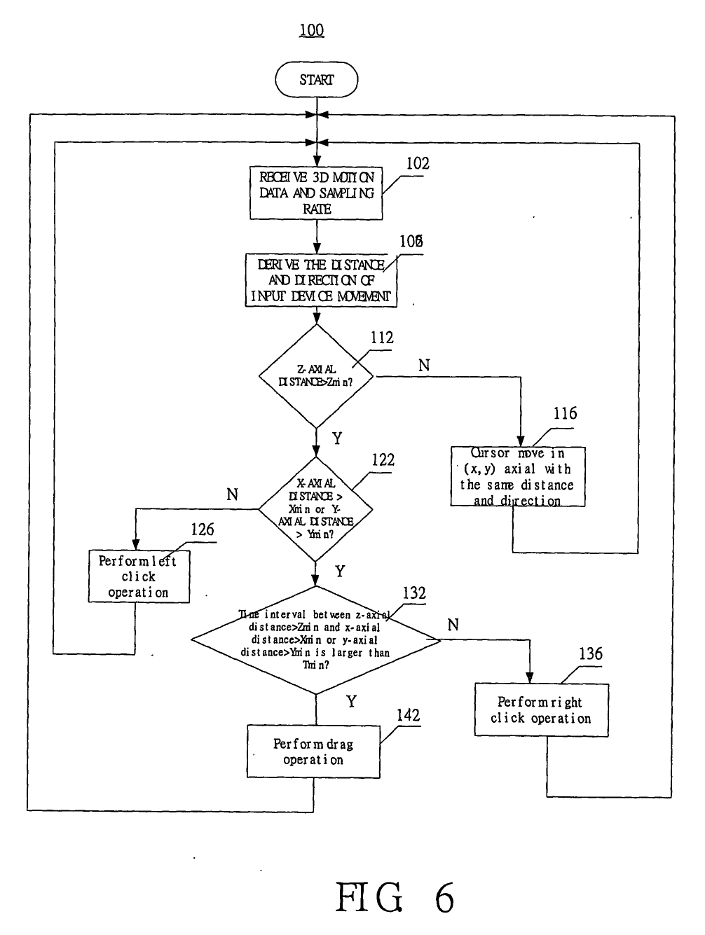

FIG. 4 shows an input device 80 connected to a computer 30 according to a second embodiment of the invention. Input device 80 is similar to input device 20 in FIG. 1, except that it does not include the two control buttons. In this embodiment, the 3D motion data received by computer 30 are used in a different way. Specfically, the movement on the x and y axes are used for deriving the distance and direction of the cursor movement, while the movement on z axis is a determining factor in detecting cursor actions, e.g., click and drag operations, as will be explained in detailed in connection with FIG. 6.

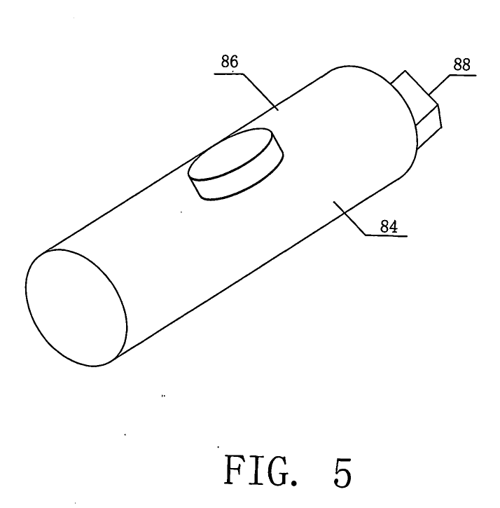

FIG. 5 shows an exemplary external design of input device 80 according to the second embodiment of the invention. As shown in FIG. 5, input device 80 includes a stem 84 having a recess 86, and a 3D motion detection sensor IC chip 88 mounted on stem 84. The user can simply hold stem 84 at recess 86 with an index finger so as to fix the relative position of input device 80 with respect to the user's hand. Alternatively, a pointing object may be attached to stem 84 in place of recess 86 as a reference point for use to fix the relative position of input device 80 with respect to the user's hand. Then the user can freely move input device 80 in a 3D space to point to icons on the computer display. To perform click operations, the user would need to move stem 84 toward a plane perpendicular to the longitudinal direction of the stem, as will be further explained in connection with FIG. 6.

FIG. 6 is a flowchart diagram illustrating a process 100 performed by computer 30 according to the second embodiment of the invention. In FIG. 6, computer 30 receives the 3D motion data and the sampling rate from input device 20 (step 102), and derives the distance and direction of the input device movement based on the information received (step 106), in the same manner as steps 52 and 56 respectively in FIG. 3.

A determination is made as to whether the movement along the z axis is greater than a predetermined absolute value zₘᵢₙ (e.g., 3 cm) (step 112). If the determination is negative, it indicates that cursor action is not intended. Hence computer 30 moves the cursor along the x and y axes to a corresponding position in a usual manner, based on the movement of the input device on the x and y axes.

On the other hand, if the determinaiton is positive at step 112, it indicates that a cursor action is intended. To distinguish which of the cursor actions, i.e., left click, right click or drag operation, is intended, another determination is made as to whether the movement of the input device along either the x or y axis is greater than the absolute value xₘᵢₙ (e.g., 3 cm) or yₘᵢₙ (e.g., 3 cm), respectively (step 122). If neither is the case, it indicates that the input device move along the z-axis only. Thus, the action is interpreted as a simple click, and computer 30 will perform a left click operation (step 126).

On the other hand, if, at step 122, either the x-axial distance is greater than xₘᵢₙ or the y-axial distance is greater than yₘᵢₙ, or both, it indicates that other cursor action is likely to be intended. Then, a determination is made as to whether the time interval between z-axial distance>zₘᵢₙ and x-axial distance>xₘᵢₙ or y-axial distance>yₘᵢₙ is less than tₘᵢₙ (e.g., 200 ms)(step 132). If the determination is negative, it indicates that the input device did not move far enough along the x and y axes. Thus, the action is interpreted as a right click, and computer 30 will perform a right click operation (step 136). If the determination is positive at step 132, it indicates that two sequential actions are intended, i.e., a click action followed by a drag action. Thus, computer 30 will perform a dragging operation (step 142). In such case, the distances of the input device along the x and y axes are used to determine the drag distance on the display.

In the above, the invention has been described in connection with a computer. Other computing devices, such as handheld devices, may also be used instead of the computer.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. An input device, comprising:
a motion detection sensor that is configured to generate three-dimensional (3D) motion data associated with 3D movement of the input device;
means for transmitting the motion data to a computer;
means for causing the computer derive a distance and direction of the movement of the input device in a two-dimensional plane based on the motion data; and
means for causing the computer to move a cursor to a corresponding position based on the distance and direction derived.

2. The device of claim 1, wherein the transmitting means wirelessly transmits the motion data.

3. The device of claim 1, further comprising means for generating control signals, in response to a user's command, for causing the computer to perform a corresponding cursor action.

4. The device of claim 3, wherein the cursor action includes one of the following: a left click operation, a right click operation, a double click operation, and a click and drag operation.

5. Computer-readable media tangibly embodying a program of instructions executable by a computer to perform a method of controlling a cursor of the computer in response to operation of an input device, the method comprising the steps of:
receiving three-dimensional (3D) motion data associated with 3D movement of the input device;
deriving a distance and direction of the movement of the input device in a two-dimensional plane based on the motion data; and
moving a cursor of the computer to a corresponding position based on the distance and direction derived.

6. The media of claim 5, wherein the method further comprises a step of performing a corresponding cursor action in response to a control signal received from the input device, upon a user's command.

7. The media of claim 6, wherein the cursor action includes one of the following: a left click operation, a right click operation, a double click operation, and a click and drag operation.

8. A computer system, comprising:
an input device including:
a motion detection sensor that is configured to generate three-dimensional (3D) motion data associated with 3D movement of the input device, and
means for transmitting the 3D motion data; and
a computing device including:
means for receiving the motion data from the input device,
means for deriving a distance and direction of the movement of the input device in two-dimensional plane based on the motion data, and
means for moving a cursor of the computing device to a corresponding position based on the distance and direction derived.

9. The system of claim 8, wherein the transmitting means wirelessly transmits the 3D motion data.

10. The system of claim 9, wherein the input device further comprises means for generating control signals, in response to a user's command, for causing the computer to perform a corresponding cursor action.

11. The system of claim 10, wherein the cursor action includes one of the following: a left click operation, a right click operation, a double click operation, and a click and drag operation.

12. A method for controlling a cursor of a computer in response to operation of an input device, the method comprising the steps of:
receiving three-dimensional (3D) motion data associated with 3D movement of the input device from the input device;
deriving a distance and direction of the movement of the input device in two-dimensional plane based on the motion data; and
moving the cursor of the computer to a corresponding position based on the distance and direction derived.

13. The method of claim 12, further comprising a step of performing a corresponding cursor action in response to received control signals transmitted by the input device, upon a user's command.

14. The method of claim 13, wherein the cursor action includes one of the following: a left click operation, a right click operation, a double click operation, and a click and drag operation.

15. An input device, comprising:
a motion detection sensor that is configured to generate three-dimensional (3D) motion data on first, second and third axes, associated with 3D movement of the input device;
means for transmitting the motion data to a computer;
means for causing the computer derive a distance and direction of the movement of the input device in a two-dimensional (2D) plane based on the motion data on the first and second axes;
means for causing the computer to determine whether the motion data on the third axis is greater than a first predetermined value; and
means for causing the computer to move a cursor to a corresponding position based on the distance and direction derived in the 2D plane, upon the computer determining the motion data on the third axis is greater than the first predetermined value.

16. The device of claim 15, wherein the transmitting means wirelessly transmits the motion data.

17. The device of claim 15, further comprising:
means for causing the computer to determine whether the motion data on the first and second axes are greater than second and third pre-determined values, respectively; and
means for causing the computer to perform a left click operation, upon the computer determining either the motion data on the first axis are greater than the second predetermined value or the motion data on the second axis are greater than the third predetermined value.

18. The device of claim 17, further comprising:
means for causing the computer to determine whether a time interval is greater than a predetermined duration, the time interval being between the motion data on the third axis being greater than the first predetermined minimum value and the motion data on the first axis being greater than the second predetermined value or the motion data on the second axis being greater than the third predetermined value;
means for performing a drag operation upon the computer determining the time interval is greater than the predetermined duration; and
means for performing a right click operation upon the computer determining the time interval is not greater than the predetermined duration.

19. Computer-readable media tangibly embodying a program of instructions executable by a computer to perform a method of controlling a cursor of the computer in response to operation of an input device, the method comprising the steps of:
receiving three-dimensional (3D) motion data on first, second and third axes, associated with 3D movement of the input device;
deriving a distance and direction of the movement of the input device in a two-dimensional (2D) plane based on the motion data on the first and second axes;
determining whether the motion data on the third axis is greater than a first predetermined value; and
moving a cursor of the computer to a corresponding position based on the distance and direction derived in the 2D plane, upon determining the motion data on the third axis is greater than the first predetermined value.

20. The media of claim 19, wherein the method further comprises:
determining whether the motion data on the first and second axes are greater than second and third pre-determined values, respectively; and
performing a left click operation, upon determining either the motion data on the first axis are greater than the second predetermined value or the motion data on the second axis are greater than the third predetermined value.

21. The media of claim 20, further comprising:
determining whether a time interval is greater than a predetermined duration, the time interval being between the motion data on the third axis being greater than the first predetermined minimum value and the motion data on the first axis being greater than the second predetermined value or the motion data on the second axis being greater than the third predetermined value;
performing a drag operation, upon determining the time interval is greater than the predetermined duration; and
performing a right click operation, upon determining the time interval is not greater than the predetermined duration.

22. A computer system, comprising:
an input device including:
a motion detection sensor that is configured to generate three-dimensional (3D) motion data on first, second and third axes, associated with 3D movement of the input device, and
means for transmitting the motion data to a computer; and
a computing device including:
means for deriving a distance and direction of the movement of the input device in a two-dimensional (2D) plane based on the motion data on the first and second axes,
means for determining whether the motion data on the third axis is greater than a first predetermined value, and
means for moving a cursor to a corresponding position based on the distance and direction derived in the 2D plane, if the motion data on the third axis are greater than the first predetermined value.

23. The system of claim 22, wherein the transmitting means wirelessly transmits the motion data.

24. The system of claim 22, wherein the computing device further comprises:
means for determining whether the motion data on the first and second axes are greater than second and third pre-determined values, respectively, and
means for performing a left click operation, if either the motion data on the first axis are greater than the second predetermined value or the motion data on the second axis are greater than the third predetermined value.

25. The system of claim 24, wherein the computing device further comprises:
means for determining whether a time interval is greater than a predetermined duration, the time interval being between the motion data on the third axis being greater than the first predetermined minimum value and the motion data on the first axis being greater than the second predetermined value or the motion data on the second axis being greater than the third predetermined value,
means for performing a drag operation, if the time interval is greater than the predetermined duration, and
means for performing a right click operation, if the time interval is not greater than the predetermined duration.

26. A method for controlling a cursor of a computer in response to operation of an input device, the method comprising the steps of:
receiving three-dimensional (3D) motion data on first, second and third axes, associated with 3D movement of the input device;
deriving a distance and direction of the movement of the input device in a two-dimensional (2D) plane based on the motion data on the first and second axes;
determining whether the motion data on the third axis is greater than a first predetermined value; and
moving a cursor of the computer to a corresponding position based on the distance and direction derived in the 2D plane, if the motion data on the third axis is greater than the first predetermined value.

27. The method of claim 26, further comprising:
determining whether the motion data on the first and second axes are greater than second and third pre-determined values, respectively; and
performing a left click operation, if either the motion data on the first axis are greater than the second predetermined value or the motion data on the second axis are greater than the third predetermined value.

28. The media of claim 20, further comprising:
determining whether a time interval is greater than a predetermined duration, the time interval being between the motion data on the third axis being greater than the first predetermined minimum value and the motion data on the first axis being greater than the second predetermined value or the motion data on the second axis being greater than the third predetermined value;
performing a drag operation, if the time interval is greater than the predetermined duration; and
performing a right click operation, if the time interval is not greater than the predetermined duration.
